(19) United States
(12) Patent Application Publication
(10) Pub. No.: US 2008/0102183 A1
(43) Pub. Date: May 1, 2008

(54) Enriched dough, batter, and bakery goods prepared therefrom

(76) Inventors: Timothy Christensen, Maple Grove, MN (US); Gary M. Geist, Blaine, MN (US); Melanie J. Goulson, Dayton, MN (US); Jody L. Mattsen, Inver Grove Heights, MN (US)

Correspondence Address: FISH & RICHARDSON P.C., PO BOX 1022, MINNEAPOLIS, MN, 55440-1022, US

(21) Appl. No.: 11/586,258

(22) Filed: Oct. 25, 2006

(51) Int. Cl. A21D 10/00

(52) U.S. Cl. 426/549

(57) ABSTRACT

Doughs and batters may be prepared that include sweetener, fat, EPA/DHA Omega 3 fatty acids, flour, and optionally cinnamon. Bakery goods may be prepared from the described doughs or batters.

### TECHNICAL FIELD

This invention relates to dough, batter, and bakery goods.

### BACKGROUND

Omega-3 fatty acids, and, in particular, eicosapentaenoic acid (EPA) and docosahexaenoic acid (DHA), have been found to confer various health benefits when ingested. Although these fatty acids are typically found in fish, many individuals do not like to eat fish. Consequently, an interest in fortifying other types of foods with Omega-3 fatty acids has developed. One problem with such efforts, however, is that the Omega-3 fatty acids oxidize readily and develop an undesirable “fishy” taste or odor.

### SUMMARY

A dough or batter is described that includes: (a) at least 1% by weight sweetener; (b) at least 1% by weight fat; (c) at least 0.01% by weight cinnamon; (d) an EPA/DHA Omega-3 fatty acid; and (e) flour. As used herein, “fat” refers to shortening, butter, margarine, non-Omega-3 fatty acids and oils, and combinations thereof. As used herein, “cinnamon” refers to cinnamon powders, extracts, oils, and derivatives. As used herein, the term “sweetener” includes, without limitation, sucrose and high fructose corn syrup.

In one embodiment, the amount of the Omega-3 fatty acid may be selected to provide at least 50 mg of EPA/DHA Omega 3 fatty acids per 50 g of a bakery good prepared from the dough or batter, and may range between 50 mg and 150 mg. In one embodiment, the amount of sweetener may range from 1 to 10% by weight; the amount of fat may range from 1 to 10% by weight; and the amount of cinnamon may range from 0.01 to 2.5% by weight. In some embodiments, the sweetener may comprise sugar, or may comprise high fructose corn syrup. In some embodiments, the amount of cinnamon may be at least 0.50% by weight, or may be at least 0.75% by weight.

A dough or batter is also described that includes: (a) at least 5% by weight sweetener; (b) at least 5% by weight fat; (c) an EPA/DHA Omega-3 fatty acid; and (d) flour. The dough or batter may further include from 0.01 to 2.5% by weight cinnamon. In some embodiments, the amount of the EPA/DHA Omega-3 fatty acids in the dough or batter may be selected to provide at least 50 mg of EPA/DHA fatty acids per 50 g of a bakery good prepared from the dough; the amount of sweetener may range from 5 to 10% by weight; and the amount of fat may range from 5 to 10% by weight. In some embodiments, the sweetener may comprise sugar, or may comprise high fructose corn syrup.

Bakery goods may be prepared from a described dough or batter by baking, cooking, or frying the dough or batter. The resulting bakery goods may resist developing an objectionable “fishy” taste or odor after being stored for several days.

The details of one or more embodiments of the invention are set forth in the accompanying description below. Other features, objects, and advantages of the invention will be apparent from the description and from the claims.

### DETAILED DESCRIPTION

A dough or batter may include: (a) at least 1%, and typically between 1 and 10%, by weight sweetener; (b) at least 1%, and typically between 1 and 10%, by weight fat; (c) at least 0.01%, and typically between 0.01 and 2.5% by weight cinnamon; (d) an Omega-3 fatty acid; and (e) flour.

Another dough or batter may include: (a) at least 5%, and typically between 5 and 10%, by weight sweetener; (b) at least 5%, and typically between 5 and 10%, by weight fat; (c) an EPA/DHA Omega-3 fatty acid; and (d) flour. The dough or batter may further include from 0.01 to 2.5% by weight cinnamon.

The sweetener component may be provided by various sweeteners. Examples of sweeteners that may be used include sugars such as sucrose or fructose, high fructose corn syrup (“HFCS”), honey, and other natural and artificial sweeteners. In one embodiment, sucrose, high fructose corn syrup, or a combination thereof may be used in the dough or batter. The amount of sweetener used may depend upon a number of factors, including the type of sweetener used, the type of bakery good to be produced, and the type and amount of the other components used to produce the dough or batter. In one embodiment, the amount of sweetener may be 1% wt. or more, 2% wt. or more, 3% wt. or more, or 5% wt. or more of the dough or batter, and may be 15% wt. or less, 12% wt. or less, or 10% wt. or less of the dough or batter. In another embodiment, the amount of sweetener may be 5% wt. or more, 6% wt. or more, or 7% wt. or more of the dough or batter, and may be 15% wt. or less, 12% wt. or less, or 10% wt. or less of the dough or batter.

The fat component may be provided by various fat containing products. Fat containing products that may be used to provide the fat component include for example, shortening, butter, margarine, and non-Omega-3 fatty acids and oils. In various embodiments, combinations of products may be used to provide the fat component. The amount of fat used may depend upon a number of factors, including the type of fat product used, the type of bakery good to be produced, and the type and amount of the other components used to produce the dough or batter. In one embodiment, the amount of fat may be 1% wt. or more, 2% wt. or more, 3% wt. or more, or 5% wt. or more of the dough or batter, and may be 15% wt. or less, 12% wt. or less, or 10% wt. or less of the dough or batter. In another embodiment, the amount of fat may be 5% wt. or more, 6% wt. or more, or 7% wt. or more of the dough or batter, and may be 15% wt. or less, 12% wt. or less, or 10% wt. or less of the dough or batter.

The optional cinnamon component is a natural based ingredient that is available in various forms. For example, the cinnamon component may be provided by cinnamon powders, extracts, oils, and derivatives. The amount of cinnamon used may depend upon a number of factors, including the type of cinnamon product used, the type of bakery good to be produced, and the type and amount of the other components used to produce the dough or batter. In various embodiments, the amount of cinnamon may be 0.01% wt. or more, 0.02% wt. or more, 0.05% wt. or more, 0.1% wt. or more, 0.25% wt. or more, 0.5% wt. or more, 0.75% wt. or more, or 1% wt. or more of the dough or batter, and may be 5% wt. or less, 4% wt. or less, 3% wt. or less, or 2.5% wt. or less of the dough or batter.

The EPA/DHA Omega-3 fatty acid component may be supplied from fish oil or plant oil. Examples of suitable oils include cod liver oil, Omega Protein OmegaPure Menhaden Oil, Martek algal oil, and Denomega Nutritional Oils AS Denomega 100 fish oil. In one embodiment, the amount of EPA/DHA fatty acids included in the dough or batter can be selected to provide at least 50 mg of EPA/DHA fatty acids per 50 g of a bakery good prepared from the dough or batter. In other embodiments, the amount of EPA/DHA fatty acids included in the dough or batter can be selected to provide at least 75 mg, at least 100 mg, or at least 125 mg of EPA/DHA fatty acids per 50 g of a bakery good prepared from the dough or batter. In various embodiments, the amount of EPA/DHA fatty acids included in the dough or batter can be selected to provide up to 300 mg, up to 250 mg, up to 200 mg, or up to 150 mg of EPA/DHA fatty acids per 50 g of a bakery good prepared from the dough or batter.

The flour component may be provided by a variety of sources. Typically, the flour component will be grain-based. Examples of grains that may be used to produce flour include wheat, barley, corn, rye, and oats, as well as other grains. The flour component may be provided from a single grain type, or from a mixture of grains. The flour component may also be treated prior to use. For example, the flour component may be a non-gluten flour. The amount of flour used may be based on the other components used, and the proper amount of flour should be used to form a dough or batter of the proper consistency.

Liquids will also generally be used with the other components to produce the dough or batter. Typically, the liquids that may be used include water and milk, but other liquids may also be used. The amount of liquids used may be based on the other components used, and the proper amount of liquids should be used to form a dough or batter of the proper consistency.

The dough or batter may also include additional optional ingredients such as yeast, salt, eggs, colorants, and/or preservatives. The amounts of these ingredients are selected based upon the desired qualities of the bakery goods prepared from the dough or batter.

The dough or batter can be prepared by combining the above-described ingredients using conventional methods. In some methods, all the ingredients are combined together to form the dough or batter. In other methods, some of the sugar and cinnamon is reserved while the other components are combined. Generally, the components may be combined sequentially, all at once, or in various combinations.

After mixing, the dough or batter may be prepared in various ways. In one embodiment, the dough may only be separated for cooking after mixing. In one embodiment, a dough may be prepared, sheeted, sprinkled with a reserved sugar/cinnamon mixture, and rolled up to produce a cinnamon swirl dough for producing a cinnamon swirl bread.

The dough or batter may be baked, fried, or otherwise cooked to produce a bakery good. Examples of bakery goods that may be produced include breads, rolls, muffins, doughnuts, bagels, cakes, cookies, scones and the like.

### EXAMPLES

### Example 1

### Control

A dough was prepared using the ingredients listed in Table 1, column 1. The ingredients were mixed together in a bowl using a kitchen mixer for 1 minute at low speed and 6 minutes at medium speed. The dough was then allowed approx. 20 minutes of floor time. The dough was then cut up, and allowed to rest for an additional approx. 15 minutes. Then, 640 grams of dough were weighed and sheeted down to 3 mm thickness. The dough was then lightly coated with an oil/water mixture.

A cinnamon/sugar mixture was produced by mixing 8 parts of sugar to 1 part of cinnamon. Then 45 grams of the cinnamon/sugar mixture was uniformly spread over the dough to form coated dough, and the coated dough rolled into a log shape. After rolling, the coated dough was placed in a loaf pan and then proofed for 30-45 minutes. After proofing, the dough was baked in an oven with the oven temperature set to 400° F. for 28 minutes, producing a loaf of cinnamon swirl bread. The bread was removed from the oven, depanned, placed on a rack, and allowed to cool for approximately 1 hour. The loaf was then sliced and packaged into a plastic bag.

### Example 2

Additional bread samples were made and tested following the procedure of Example 1, except that the ingredients listed in column 2 of Table 1 were used. The ingredients included fish oil containing Omega-3 fatty acids.

### Example 3

Additional bread samples were made and tested following the procedure of Example 1, except that the ingredients listed in column 3 of Table 1 were used. The ingredients included fish oil containing Omega-3 fatty acids.

### Example 4

Additional bread samples were made and tested following the procedure of Example 1, except that the ingredients listed in column 4 of Table 1 were used. The ingredients included fish oil containing Omega-3 fatty acids.

TABLE 1
Dough Formulas for Production of Bread Enriched
with 0 to 300 mg EPA&DHA Omega-3 Fatty Acids
per 50 g Serving of Finished Bread

| | 1 | 2 | 3 | 4 |
|---|---|---|---|---|
| | 0 mg | 75 mg | 150 mg | 300 mg |
| Ingredient (%) | EPA&DHA | EPA&DHA | EPA&DHA | EPA&DHA |
| Flour | 53.11 | 53.11 | 53.11 | 53.16 |
| Sugar | 3.19 | 3.19 | 3.19 | 3.19 |
| Shortening | 3.19 | 2.74 | 2.18 | 1.06 |
| Denomega | 0 | 0.45 | 1.01 | 2.02 |
| 100* | | | | |
| (Denomega | | | | |
| Nutritionals) | | | | |
| Emulsifier | 0.26 | 0.26 | 0.26 | 0.27 |
| (Panolite; | | | | |
| ADM) | | | | |
| Nonfat Dry | 1.59 | 1.59 | 1.59 | 1.59 |
| Milk (Land | | | | |
| O' Lakes) | | | | |
| Salt | 0.96 | 0.96 | 0.96 | 0.96 |
| Dough | 0.26 | 0.26 | 0.26 | 0.27 |
| Conditioner | | | | |
| (S-500 Red; | | | | |
| Purados) | | | | |
| Yeast | 3.98 | 3.98 | 3.98 | 3.99 |
| Water | 33.46 | 33.46 | 33.46 | 33.49 |
| Total | 100.00 | 100.00 | 100.00 | 100.00 |

*Denomega 100 Cod Liver Oil contained approximately 25% EPA&DHA

### Example 5

Breads produced according to Examples 1-4 were evaluated periodically using a panel of judges with experience in tasting Omega 3 products. From one to four judges were used for each evaluation. The judges rated the bread in the following categories: taste, moistness, overall liking, and smell. The scale used was from 1 (Good) to 5 (Poor). The scores of the judges were averaged to arrive at the overall score for each sample for each day. The results of the evaluations are reported in Table 2.

TABLE 2
Sensory Evaluation Results during Production and
Shelf-Life of Bread Enriched with 0 to 300 mg
EPA&DHA Omega-3 Fatty Acids per 50 g Serving

| | | | |
|---|---|---|---|
| 1 | 2 | 3 | 4 |
| 0 mg | 75 mg | 150 mg | 300 mg |
| EPA&DHA | EPA&DHA | EPA&DHA | EPA&DHA |

Fishy Odor Intensity During Production

| | | | | |
|---|---|---|---|---|
| Mixing | 1 | 1 | 1 | 1 |
| Pre-Baking | 1 | 1 | 1 | 1 |
| During Baking | 1 | 1 | 2 | 2 |

Average Fishy Flavor Intensity During Shelf-Life

| | | | | |
|---|---|---|---|---|
| Day 1 | 1.8 | 1.8 | 1.6 | 4.2 |
| Day 3 | 1.2 | 1.2 | 2.7 | 4 |
| Day 4 | 1 | 1 | 1.3 | x |
| Day 6 | 1 | 1 | 1 | x |
| Day 7 | 1.4 | 2 | 1.8 | x |
| Day 8 | 1 | 1 | 1 | x |
| Day 9 | 1 | 1 | 2 | x |
| Day 10 | 1 | 1 | 2 | x |
| Day 11 | m | m | m | x |

Overall Liking Score During Shelf-Life

| | | | | |
|---|---|---|---|---|
| Day 1 | 1.8 | 1.6 | 1.6 | 4.2 |
| Day 3 | 1.2 | 1.2 | 1.5 | 5 |
| Day 4 | 1 | 1.3 | 1.7 | x |
| Day 6 | 1 | 1 | 1 | x |
| Day 7 | 2.6 | 2.2 | 2.2 | x |
| Day 8 | 2 | 2 | 2 | x |
| Day 9 | 2 | 2 | 2 | x |
| Day 10 | 2 | 2 | 2 | x |
| Day 11 | m | m | m | x |

Scale from 1(Good) to 5(Poor),
m = moldy (end of shelf-life),
x = not tested due to product failure

These results demonstrate that:
The fishy odor intensity of bread dough containing EPA&DHA (75 to 300 mg per serving) was equal to or only slightly greater than the untreated control dough during preparation and baking and judged to be acceptable.
The fishy flavor intensity of bread containing 75 to 150 mg EPA&DHA per serving was equivalent to the untreated control bread for the first 8 days of shelf storage. The fishy flavor intensity of the 75 to 150 mg treatments was rated only slightly greater than the control during the last two days of shelf-life, but still received an acceptable rating.
The fishy flavor intensity of bread containing 300 mg of EPA & DHA per serving was rated as definite to strong from Day 1 and judged to be unacceptable based on poor ratings.

### Example 6

A series of breads were produced with cinnamon content of 0.02% to 1.00%. Bread batch sizes were approx. 2100-2200 grams. Two loaves of bread were produced for each formulation. Breads were produced using the ingredients reported in Table 3 as follows:
1. The vegetable oil and fish oil were gently blended together in a cup and set aside.
2. The cinnamon was blended with the other dry ingredients in a bowl (except for the yeast) and set aside.
3. Water was added to a mixer bowl, followed by the addition of yeast, and then the pre-blended dry ingredients.
4. The mixture was mixed for 1 minute at speed 1 (low) to blend in the free liquid water.
5. The pre-blended oil was added, and then mixed for an additional minute at speed 1.
6. The entire mixture was mixed for 5 minutes at speed 2 (medium). The mixer was then stopped, the dough manually flipped, and then the mixing continued for an additional 2 minutes at speed 2.
7. The dough was allowed to rest for 10 minutes at ambient temperature (floor rest).
8. The dough was then scaled to approx. 800 gram portions, rounded, dusted with flour, and then allowed to rest for 15 minutes.
9. The dough pieces were then molded using a Moline sheeter/molder (Roller Gap=2, Pressure board=6.5).
10. The ends of the dough were sealed, the dough placed in commercial pans, and the pans labeled.
11. The loaves were proofed for 50 minutes (at 105° F. and ˜80% RH).
12. The loaves were transferred to a Reel Oven, and baked at an oven temperature of 400° F. for 24 minutes.
13. The loaves were removed from the oven, de-panned, and cooled on a cooling rack at room temperature for 60 minutes.
14. After cooling for 60 minutes, the loaves were sliced, packaged in a plastic bag, and labeled.
15. The loaves of bread were stored on a lab bench at ambient temperature (˜70° F.) for the duration of the shelf life study.

TABLE 3
Dough Formulas for Production of Bread Enriched with 135–140 mg EPA&DHA
Omega-3 Fatty Acids per 50 g Serving of Finished Bread

| | 6.1 | 6.2 | 6.3 | 6.4 | 6.5 | 6.6 | 6.7 | 6.8 | 6.9 |
|---|---|---|---|---|---|---|---|---|---|
| | Control- | Control- | Cinnamon | Cinnamon | Cinnamon | Cinnamon | Cinnamon | Cinnamon | Cinnamon |
| | pos | neg | 0.02% | 0.05% | 0.10% | 0.25% | 0.50% | 0.75% | 1.00% |
| Ingredients (%) | no ω-3 | with ω-3 | with ω-3 | with ω-3 | with ω-3 | with ω-3 | with ω-3 | with ω-3 | with ω-3 |
| Artisan Flour | 55.224 | 55.194 | 55.182 | 55.166 | 55.138 | 55.055 | 54.912 | 54.771 | 54.629 |
| (Enriched), Cargill | | | | | | | | | |
| HFCS, Isoclear 42%, | 4.004 | 4.051 | 4.05 | 4.049 | 4.047 | 4.041 | 4.031 | 4.02 | 4.01 |
| Cargill | | | | | | | | | |
| Salt-Not Iodized, | 1.104 | 1.104 | 1.104 | 1.103 | 1.103 | 1.101 | 1.098 | 1.095 | 1.093 |
| Cargill | | | | | | | | | |
| S--500 Red (dough | 0.828 | 0.828 | 0.828 | 0.827 | 0.827 | 0.826 | 0.824 | 0.822 | 0.819 |
| conditioners), Purados | | | | | | | | | |
| Soybean Oil- | 3.037 | 1.623 | 1.622 | 1.622 | 1.621 | 1.619 | 1.62 | 1.616 | 1.617 |
| Masterchef, Cargill | | | | | | | | | |
| OmegaPure Fish Oil, | 0 | 1.418 | 1.418 | 1.418 | 1.417 | 1.415 | 1.417 | 1.419 | 1.417 |
| Omega Protein | | | | | | | | | |
| Panolite 50 SVK | 0.276 | 0.276 | 0.276 | 0.276 | 0.276 | 0.275 | 0.275 | 0.274 | 0.273 |
| (emulsifier), ADM | | | | | | | | | |
| Fresh Yeast-Eagle, | 2.209 | 2.208 | 2.207 | 2.207 | 2.206 | 2.202 | 2.196 | 2.191 | 2.185 |
| Lallemand | | | | | | | | | |
| Water | 33.136 | 33.116 | 33.111 | 33.1 | 33.083 | 33.033 | 32.946 | 32.861 | 32.777 |
| Calcium Propionate- | 0.182 | 0.182 | 0.182 | 0.182 | 0.182 | 0.182 | 0.181 | 0.181 | 0.18 |
| 2559, Fleischmann's | | | | | | | | | |
| Cinnamon (no sugar), | 0 | 0 | 0.02 | 0.05 | 0.1 | 0.251 | 0.5 | 0.75 | 1 |
| McCormick | | | | | | | | | |
| Total % | 100 | 100 | 100 | 100 | 100 | 100 | 100 | 100 | 100 |

The EPA/DHA content of the bread was analyzed at the start and the end of the shelf life study. The EPA/DHA content of the bread was consistent at 135 mg to 140 mg per slice at both the start and end of the study. The breads were evaluated for odor as they were removed from the pans, and after cooling. In addition, the breads were evaluated for odor and appearance at the time of slicing. The results of these evaluations are reported on Table 4.

TABLE 4
Sensory Evaluation Results during Production
of Bread Enriched with 135–140 mg
EPA&DHA Omega-3 Fatty Acids per 50 g Serving

| Ex | Odor: Hot | Odor: Cool | Color: Sliced and Cooled |
|---|---|---|---|
| 6.1 | No Odor | No Odor | White, no brown specks |
| 6.2 | Slight to moderate | No Odor | White, no brown specks |
| | fish odor | | |
| 6.3 | Slight fish odor | No Odor | White, no brown specks |
| 6.4 | Slight fish odor | No Odor | White, no brown specks |
| 6.5 | Slight fish odor | No Odor | White, a few brown specks |
| 6.6 | Slight fish odor | No Odor | Tan, some brown specks |
| 6.7 | Slight fish odor | No Odor | Tan, brown specks |
| 6.8 | Slight fish odor | No Odor | Tan to brown, brown specks |
| 6.9 | Slight fish odor | No Odor | Brown, brown specks |

The breads were stored at ambient temperature. Sensory evaluation testing was conducted at 1, 3, 7, 10, 13, 15, and 17 days after baking. Samples were rated for fishy odor and flavor on a scale from 0 (none) to 9 (extreme) by a panel of judges with experience in tasting Omega 3 products. A sample was considered to have an “Acceptable Intensity Score” if it received an overall average intensity score of not greater than 1.5 (equivalent to trace to faint odor/taste).

Table 5 reports the overall summary of the sensory evaluation results, interpreted and expressed in days of acceptable shelf life. Typically, commercial breads have approximately 12 days of shelf life. In this example, the positive control (no fish oil) bread had acceptable scores at 17 days.

In addition, an overall acceptability rating was assigned by each judge, with the rating being a binary scale of accept or reject. For this rating, a sample was considered to have an “Acceptable Rating” if it received an overall acceptable rating from at least 75% of the judges. In general, fishy flavor intensity scores were given the highest priority in forming conclusions.

TABLE 5
Sensory Evaluation Results during Shelf-Life of Bread Enriched with
135–140 mg EPA&DHA Omega-3 Fatty Acids per 50 g Serving

| | | | # Days with | | | |
|---|---|---|---|---|---|---|
| | | | Acceptable | | # Days with | |
| | | | Intensity | | Acceptable | |
| | | | Score | | Rating | |
| Ex | % Cinnamon | Omega-3 | Odor | Flavor | Odor | Flavor |
| 6.1 | 0 | Pos Control-No | 17 | 17 | 17 | 17 |
| | | Omega-3 | | | | |
| 6.2 | 0 | Neg Control-With | 7 | 3 | 3 | 3 |
| | | Omega-3 | | | | |
| 6.3 | 0.02 (200 ppm) | With Omega-3 | 3 | 3 | 3 | 3 |
| 6.4 | 0.05 (500 ppm) | With Omega-3 | 13 | 3 | 7 | 10 |
| 6.5 | 0.1 (1000 ppm) | With Omega-3 | 10 | 3 | 3 | 3 |
| 6.6 | 0.25 | With Omega-3 | 7 | 3 | 7 | 3 |
| 6.7 | 0.5 | With Omega-3 | 17 | 15 | 13 | 15 |
| 6.8 | 0.75 | With Omega-3 | 17 | 17 | 17 | 17 |
| 6.9 | 1 | With Omega-3 | 17 | 17 | 17 | 17 |

In summary, bread having an amount of cinnamon equal to or greater than 0.5% by weight cinnamon with the other components used exhibited good results throughout the normal shelf life of 12 days and was comparable to the positive control.

A number of embodiments of the invention have been described. Nevertheless, it will be understood that various modifications may be made without departing from the spirit and scope of the invention. Accordingly, other embodiments are within the scope of the following claims.

What is claimed is:

1. A dough or batter comprising:
(a) at least 1% by weight sweetener;
(b) at least 1% by weight fat;
(c) at least 0.01% by weight cinnamon;
(d) an EPA/DHA Omega 3 fatty acid; and
(e) flour.

2. A dough or batter according to claim 1, wherein the amount of EPA/DHA Omega 3 fatty acids is sufficient to provide at least 50 mg of EPA/DHA Omega 3 fatty acids per 50 g of a bakery good prepared from the dough or batter.

3. A dough or batter according to claim 2, wherein the amount of EPA/DHA Omega 3 fatty acids is sufficient to provide 50-150 mg of EPA/DHA Omega 3 fatty acids per 50 g of a bakery good prepared from the dough or batter.

4. A dough or batter according to claim 1, wherein the amount of sweetener is between 1 and 10% by weight.

5. A dough or batter according to claim 1, wherein the amount of fat is between 1 and 10% by weight.

6. A dough or batter according to claim 1, wherein the sweetener comprises sugar.

7. A dough or batter according to claim 1, wherein the sweetener comprises high fructose corn syrup.

8. A dough or batter according to claim 1, wherein the amount of cinnamon is between 0.01 and 2.5% by weight.

10. A dough or batter according to claim 1, wherein the amount of cinnamon is at least 0.50% by weight.

11. A dough or batter according to claim 1, wherein the amount of cinnamon is at least 0.75% by weight.

12. A dough or batter comprising:
(a) at least 5% by weight sweetener;
(b) at least 5% by weight fat;
(c) an EPA/DHA Omega 3 fatty acid; and
(d) flour.

13. The dough or batter of claim 12, wherein the sweetener comprises sucrose.

14. The dough or batter of claim 12, wherein the sweetener comprises high fructose corn syrup.

15. The dough or batter of claim 12, wherein the amount of sweetener is between 5 and 10% by weight.

16. The dough or batter of claim 12, wherein the amount of fat is between 5 and 10% by weight.

17. The dough or batter of claim 12, wherein the amount of the EPA/DHA Omega 3 fatty acid is sufficient to provide at least 50 mg of fatty acids per 50 g of a bakery good prepared from the dough or batter.

18. The dough or batter of claim 12, further comprising from 0.01 to 2.5% by weight cinnamon.

19. A bakery good prepared by baking, cooking, or frying the dough or batter of claim 1.

20. A bakery good prepared by baking, cooking, or frying the dough or batter of claim 12.
